(19) United States
(12) Patent Application Publication
(10) Pub. No.: US 2002/0002257 A1
(43) Pub. Date: Jan. 3, 2002

(54) Processes for polymerization catalysts, metal complexes and compositions containing erbium

(76) Inventors: Gary M. Diamond, San Jose, CA (US); Vince Murphy, Campbell, CA (US); Margarete K. Leclerc, Santa Clara, CA (US); Christopher Goh, San Francisco, CA (US); Keith A. Hall, San Jose, CA (US); Anne Marie LaPointe, Sunnyvale, CA (US); Thomas Boussie, Menlo Park, CA (US); Cheryl Lund, Milpitas, CA (US)

Correspondence Address: SYMYX TECHNOLOGIES INC, LEGAL DEPARTMENT, 3100 CENTRAL EXPRESS, SANTA CLARA, CA, 95051

(21) Appl. No.: 09/780,704

(22) Filed: Feb. 9, 2001

Related U.S. Application Data
(60) Provisional application No. 60/181,123, filed on Feb. 8, 2000.

(51) Int. Cl. C08F 4/72; C08F 4/06

(52) U.S. Cl. 526/170; 526/172

(57) ABSTRACT

Processes for the polymerization of monomers, particularly olefins, into polymers use erbium compositions, metal-ligand complexes and compositions. The processes proceed with good conversion in a number of different methods.

This application claims the benefit of U.S. Provisional Patent Application No. 60/181,123, filed Feb. 8, 2000, which is incorporated herein by reference for all purposes.

### FIELD OF THE INVENTION

The present invention relates to new compositions that provide useful catalysts for polymerizations, with such catalysts containing erbium.

### BACKGROUND OF THE INVENTION

Ancillary (or spectator) ligand-metal coordination complexes (e.g., organometallic complexes) and compositions are useful as catalysts, additives, stoichiometric reagents, monomers, solid state precursors, therapeutic reagents and drugs. Ancillary ligand-metal coordination complexes of this type can be prepared by combining an ancillary ligand with a suitable metal compound or metal precursor in a suitable solvent at a suitable temperature. The ancillary ligand contains functional groups that bind to the metal center(s), remain associated with the metal center(s), and therefore provide an opportunity to modify the steric, electronic and chemical properties of the active metal center(s) of the complex.

Certain known ancillary ligand-metal complexes and compositions are catalysts for reactions such as oxidation, reduction, hydrogenation, hydrosilylation, hydrocyanation, hydroformylation, polymerization, carbonylation, isomerization, metathesis, carbon-hydrogen activation, carbon-halogen activation, cross-coupling, Friedel-Crafts acylation and alkylation, hydration, dimerization, trimerization, oligomerization, Diels-Alder reactions and other transformations.

One example of the use of these types of ancillary ligand-metal complexes and compositions is in the field of polymerization catalysis. In connection with single site catalysis, the ancillary ligand offers opportunities to modify the electronic and/or steric environment surrounding an active metal center. This allows the ancillary ligand to assist in the creation of possibly different polymers.

Lanthanide based catalysts are generally known for polymerization reactions. See, generally, Anwander, R. in “Applied Homogeneous Catalysis with Organometallic Compounds”, Comils B., Herrmann W. A., Eds. (VCH Publishers, New York, 1996), Vol. 2, Section 3.2.5, pp. 866-892 and the references therein and Marks et al., Organometallics, 1999, vol. 18, pp. 2568-2570 and the references therein, all of which is incorporated herein by reference. Although erbium based catalysts have been tested in limited circumstances, they are generally considered to have low activity with respect to other lanthanide-based catalysts. See, “New coordination catalysts based on rare earth compounds for the polymerization of 1-octene”, Yang, et al., J. Polym. Sci, Part A, Polym. Chem., 1992, vol. 30, pp. 63-69; “Progress in Coordination Polymerization by Rare Earth Catalysts”, Shen, Inorganica Chimica Acta, 1987, vol. 140, pp. 7-14; and Ouyang, et al, Proc. China-U.S. Bilateral Symp. Poly. Chem. Phys. (1981), Meeting Date 1979, pp. 382-398; each of which is incorporated herein by reference. Despite these advances, higher activity of Er based catalysts has not been previously demonstrated for monomers of interest commercially. Indeed, the data presented in these cited papers suggests to those of skill in the art that Er based catalysts are not generally promising as catalysts for the polymerization of olefins, diolefins, or acetylencially unsaturated monomers. See also U.S. Pat. No. 4,057,565, which is incorporated herein by reference.

Surprisingly, it has now been discovered that Er based polymerization catalysts are particularly active. In addition, it is always a desire to discover new catalysts that will catalyze or assist in catalysis of reactions differently from known systems. This invention provides new catalyst compositions and complexes that catalyze polymerization reactions more efficiently and selectively than known systems.

### SUMMARY OF THE INVENTION

The invention disclosed herein are new catalysts comprising metal-ligand complexes or compositions of metal precursors and activators (optionally with ligands) that catalyze polymerization and copolymerization reactions, particularly with monomers that are olefins, diolefins or acetylenically unsaturated. These compositions can also polymerize monomers that have polar functionalities in homopolymerizations or copolymerizations. Also, diolefins in combination with ethylene or α-olefins or 1,1-disubstituted olefins may be co-polymerized. The new catalyst compositions are prepared by combining a metal precursor with a suitable activator and, optionally, a suitable ligand. The main feature of this invention is the use of erbium to provide the active polymerization metal center. Erbium has been investigated as a polymerization catalyst with certain ligands (see Ballard et al., J. Chem. Soc., Chem. Comm., 1978, 994-995 or U.S. Pat. No. 4,057,565, which are both incorporated herein by reference). However, the general utility of erbium as an active polymerization metal center was not previously disclosed, until this invention.

Thus, it is an object of this invention to provide polymerization catalysts that use erbium as the active metal center.

It is a further object of this invention to polymerize olefins and acetylenically unsaturated monomers with a catalyst comprised of an erbium compound or complex.

It is still a further object of this invention to polymerize olefins and acetylenically unsaturated monomers with a catalyst composition that comprises an erbium compound or complex and an activator or combination of activators.

Metal complexes, compositions or compounds using erbium and one or more ligands are within the scope of this invention. Many ligands and activators form useful polymerization catalysts with an erbium metal precursor for polymerization. Moreover, the erbium complex may be in a neutral or charged state. Thus, the erbium compounds or complexes may take may different forms, for example they may be monomeric, dimeric or higher orders thereof.

In another aspect of the invention, a polymerization process is disclosed for monomers. The polymerization process involves subjecting one or more monomers to the catalyst compositions or complexes of this invention under polymerization conditions. The polymerization process can be continuous, batch or semi-batch and can be homogeneous, supported homogeneous or heterogeneous.

Further aspects of this invention will be evident to those of skill in the art upon review of this specification.

### DETAILED DESCRIPTION OF THE INVENTION

The inventions disclosed herein include metal complexes and compositions, which are useful as catalysts for polymerization reactions.

As used herein, the phrase “characterized by the formula” is not intended to be limiting and is used in the same way that “comprising” is commonly used. The term “independently selected” is used herein to indicate that the R groups, e.g., R¹, R², R³, R⁴, and R⁵ can be identical or different (e.g. R¹, R², R³, R⁴, and R⁵ may all be substituted alkyls or R¹ and R² may be a substituted alkyl and R³ may be an aryl, etc.). A named R group will generally have the structure that is recognized in the art as corresponding to R groups having that name. The terms “compound” and “complex” are generally used interchangeably in this specification, but those of skill in the art may recognize certain compounds as complexes and vice versa. For the purposes of illustration, representative certain groups are defined herein. These definitions are intended to supplement and illustrate, not preclude, the definitions known to those of skill in the art.

The term “alkyl” is used herein to refer to a branched or unbranched, saturated or unsaturated acyclic hydrocarbon radical. Suitable alkyl radicals include, for example, methyl, ethyl, n-propyl, i-propyl, 2-propenyl (or allyl), vinyl, n-butyl, t-butyl, i-butyl (or 2-methylpropyl), etc. In particular embodiments, alkyls have between 1 and 200 carbon atoms, between 1 and 50 carbon atoms or between 1 and 20 carbon atoms.

“Substituted alkyl” refers to an alkyl as just described in which one or more hydrogen atom to any carbon of the alkyl is replaced by another group such as a halogen, aryl, substituted aryl, cycloalkyl, substituted cycloalkyl, and combinations thereof. Suitable substituted alkyls include, for example, benzyl, trifluoromethyl and the like.

The term “heteroalkyl” refers to an alkyl as described above in which one or more hydrogen atoms to any carbon of the alkyl is replaced by a heteroatom selected from the group consisting of N, O, P, B, S, Si, Sb, Al, Sn, As, Se and Ge. The bond between the carbon atom and the heteroatom may be saturated or unsaturated. Thus, an alkyl substituted with a heterocycloalkyl, substituted heterocycloalkyl, heteroaryl, substituted heteroaryl, alkoxy, aryloxy, boryl, phosphino, amino, silyl, thio, or seleno is within the scope of the term heteroalkyl. Suitable heteroalkyls include cyano, benzoyl, 2-pyridyl, 2-furyl and the like.

The term “cycloalkyl” is used herein to refer to a saturated or unsaturated cyclic non-aromatic hydrocarbon radical having a single ring or multiple condensed rings. Suitable cycloalkyl radicals include, for example, cyclopentyl, cyclohexyl, cyclooctenyl, bicyclooctyl, etc. In particular embodiments, cycloalkyls have between 3 and 200 carbon atoms, between 3 and 50 carbon atoms or between 3 and 20 carbon atoms.

“Substituted cycloalkyl” refers to cycloalkyl as just described including in which one or more hydrogen atom to any carbon of the cycloalkyl is replaced by another group such as a halogen, alkyl, substituted alkyl, aryl, substituted aryl, cycloalkyl, substituted cycloalkyl, heterocycloalkyl, substituted heterocycloalkyl, heteroaryl, substituted heteroaryl, alkoxy, aryloxy, boryl, phosphino, amino, silyl, thio, seleno and combinations thereof. Suitable substituted cycloalkyl radicals include, for example, 4-dimethylaminocyclohexyl, 4,5-dibromocyclohept-4-enyl, and the like.

The term “heterocycloalkyl” is used herein to refer to a cycloalkyl radical as described, but in which one or more or all carbon atoms of the saturated or unsaturated cyclic radical are replaced by a heteroatom such as nitrogen, phosphorous, oxygen, sulfur, silicon, germanium, selenium, or boron. Suitable heterocycloalkyls include, for example, piperazinyl, morpholinyl, tetrahydropyranyl, tetrahydrofuranyl, piperidinyl, pyrrolidinyl, oxazolinyl and the like.

“Substituted heterocycloalkyl” refers to heterocycloalkyl as just described including in which one or more hydrogen atom to any atom of the heterocycloalkyl is replaced by another group such as a halogen, alkyl, substituted alkyl, aryl, substituted aryl, heteroaryl, substituted heteroaryl, alkoxy, aryloxy, boryl, phosphino, amino, silyl, thio, seleno and combinations thereof. Suitable substituted heterocycloalkyl radicals include, for example, N-methylpiperazinyl, 3-dimethylaminomorpholinyl and the like.

The term “aryl” is used herein to refer to an aromatic substituent which may be a single aromatic ring or multiple aromatic rings which are fused together, linked covalently, or linked to a common group such as a methylene or ethylene moiety. The aromatic ring(s) may include phenyl, naphthyl and biphenyl, among others. In particular embodiments, aryls have between 1 and 200 carbon atoms, between 1 and 50 carbon atoms or between 1 and 20 carbon atoms.

“Substituted aryl” refers to aryl as just described in which one or more hydrogen atom to any carbon is replaced by one or more functional groups such as alkyl, substituted alkyl, cycloalkyl, substituted cycloalkyl, heterocycloalkyl, substituted heterocycloalkyl, halogen, alkylhalos (e.g., CF₃), hydroxy, amino, phosphido, alkoxy, amino, thio, nitro, and both saturated and unsaturated cyclic hydrocarbons which are fused to the aromatic ring(s), linked covalently or linked to a common group such as a methylene or ethylene moiety. The common linking group may also be a carbonyl as in benzophenone or oxygen as in diphenylether or nitrogen in diphenylamine.

The term “heteroaryl” as used herein refers to aromatic rings in which one or more carbon atoms of the aromatic ring(s) are replaced by a heteroatom(s) such as nitrogen, oxygen, boron, selenium, phosphorus, silicon or sulfur. Heteroaryl refers to structures that may be a single aromatic ring, multiple aromatic ring(s), or one or more aromatic rings coupled to one or more non-aromatic ring(s). In structures having multiple rings, the rings can be fused together, linked covalently, or linked to a common group such as a methylene or ethylene moiety. The common linking group may also be a carbonyl as in phenyl pyridyl ketone. As used herein, rings such as thiophene, pyridine, isoxazole, phthalimide, pyrazole, indole, furan, etc. or benzo-fused analogues of these rings are defined by the term “heteroaryl.”

“Substituted heteroaryl” refers to heteroaryl as just described including in which one or more hydrogen atoms to any atom of the heteroaryl moiety is replaced by another group such as a halogen, alkyl, substituted alkyl, aryl, substituted aryl, heteroaryl, substituted heteroaryl, alkoxy, aryloxy, boryl, phosphino, amino, silyl, thio, seleno and combinations thereof. Suitable substituted heteroaryl radicals include, for example, 4-N,N-dimethylaminopyridine.

The term “alkoxy” is used herein to refer to the —OZ¹ radical, where Z¹ is selected from the group consisting of alkyl, substituted alkyl, cycloalkyl, substituted cycloalkyl, heterocylcoalkyl, substituted heterocycloalkyl, silyl groups and combinations thereof as described herein. Suitable alkoxy radicals include, for example, methoxy, ethoxy, benzyloxy, t-butoxy, etc. A related term is “aryloxy” where Z¹ is selected from the group consisting of aryl, substituted aryl, heteroaryl, substituted heteroaryl, and combinations thereof. Examples of suitable aryloxy radicals include phenoxy, substituted phenoxy,

2-pyridinoxy, 8-quinalinoxy and the like.

As used herein the term “silyl” refers to the —SiZ¹Z²Z³ radical, where each of Z¹, Z², and Z³ is independently selected from the group consisting of alkyl, substituted alkyl, cycloalkyl, heterocycloalkyl, heterocyclic, aryl, substituted aryl, heteroaryl, substituted heteroaryl, alkoxy, aryloxy, amino, silyl and combinations thereof.

As used herein the term “boryl” refers to the —BZ¹Z² group, where each of Z¹ and Z² is independently selected from the group consisting of alkyl, substituted alkyl, cycloalkyl, heterocycloalkyl, heterocyclic, aryl, substituted aryl, heteroaryl, substituted heteroaryl, alkoxy, aryloxy, amino, silyl and combinations thereof.

As used herein, the term “phosphino” refers to the group —PZ¹Z², where each of Z¹ and Z² is independently selected from the group consisting of hydrogen, substituted or unsubstituted alkyl, cycloalkyl, heterocycloalkyl, heterocyclic, aryl, substituted aryl, heteroaryl, silyl, alkoxy, aryloxy, amino and combinations thereof

The term “amino” is used herein to refer to the group —NZ¹Z², where each of Z¹ and Z² is independently selected from the group consisting of hydrogen, alkyl, substituted alkyl, cycloalkyl, substituted cycloalkyl, heterocycloalkyl, substituted heterocycloalkyl, aryl, substituted aryl, heteroaryl, substituted heteroaryl, alkoxy, aryloxy, silyl and combinations thereof.

The term “thio” is used herein to refer to the group —SZ¹, where Z¹ is selected from the group consisting of hydrogen; alkyl, substituted alkyl, cycloalkyl, substituted cycloalkyl, heterocycloalkyl, substituted heterocycloalkyl, aryl, substituted aryl, heteroaryl, substituted heteroaryl, alkoxy, aryloxy, silyl and combinations thereof.

The term “seleno” is used herein to refer to the group —SeZ¹, where Z¹ is selected from the group consisting of hydrogen; alkyl, substituted alkyl, cycloalkyl, substituted cycloalkyl, heterocycloalkyl, substituted heterocycloalkyl, aryl, substituted aryl, heteroaryl, substituted heteroaryl, alkoxy, aryloxy, silyl and combinations thereof.

The term “saturated” refers to lack of double and triple bonds between atoms of a radical group such as ethyl, cyclohexyl, pyrrolidinyl, and the like.

The term “unsaturated” refers to the presence one or more double and triple bonds between atoms of a radical group such as vinyl, acetylide, oxazolinyl, cyclohexenyl, acetyl and the like.

### Catalytic Compositions

The main feature of this invention is the use of an erbium compound or complex as a polymerization catalyst or as a component in a composition that is a polymerization catalyst. A first embodiment of this invention is a catalytic polymerization reaction carried out using a catalytic composition, where the composition is comprised of an erbium metal precursor and a suitable polymerization activator or activating technique. In a preferred embodiment, the activator is a combination of an aluminum alkyl compound and an ionic complex that comprises a compatible, non-interfering anion. The catalytic composition may optionally include at least one ligand.

The metal precursors of this invention are erbium compounds that may be represented by the general formula ErR₃, meaning that there are three R groups attached to the erbium metal. Each R group may independently be selected from the group consisting of halide (e.g., Cl, F, I or Br), alkyl, substituted alkyl, cycloalkyl, substituted cycloalkyl, heterocycloalkyl, substituted heterocycloalkyl, cyclopentadienyl, substituted cyclopentadienyl, aryl, substituted aryl, heteroaryl, substituted heteroaryl, alkoxy, aryloxy, hydroxy, boryl, silyl, hydride, thio, seleno, phosphino, amino, carboxylates, 1,3-dionates, oxalates, carbonates, nitrates, sulfates, perchlorates, sulfonates phosphonates and combinations thereof. In other embodiments, each R is independently selected from the group consisting of halide, hydride, alkyl, substituted alkyl, aryl, substituted aryl, heteroalkyl, cyclopentadienyl, substituted cyclopentadienyl, silyl, carboxylates, 1,3-dionates, sulfonates and amino. In some embodiments, it is preferred that no two R groups are each cyclopentadienyl or alkyl-substituted or silyl-substituted cyclopentadienyl. Additional discussion of suitable R groups may be found in Schaverien “Organometallic Chemistry of the Lanthanides,” Advances in Organometallic Chemistry, 1994, vol. 36, pp. 283-362, which is incorporated herein by reference.

In some preferred embodiments, the erbium metal precursor is a homoleptic compound, meaning that each R group is the same. Such preferred embodiments include those where each R group is the same and selected from the halide, hydride, alkyl, substituted alkyl, aryl, substituted aryl, heteroalkyl, alkoxy, aryloxy, 1,3-dionates, carboxylates and amino.

Particularly preferred are those erbium precursors having bulky R groups, which are preferred because such bulky groups tend to provide additional stabilization against degradation, and increase solubility. Bulky R groups include groups such as trimethylsilyl-substituted alkyl groups (such as mono-, bis-, and tris-(trimethylsilyl)methyl), alkoxy (such as tert-butoxy), aryloxy (such as 2,6-bis(tert-butyl)phenoxy), bulky amino (such as N,N-bis(trimethylsilyl)amino) and 1,3-dionates (including the substituted versions thereof, such as 2,2,6,6-tetramethyl-3,5-heptanedionate). Also, for additional examples of bulky R groups for the homoleptic erbium metal precursors, those of skill in the art can find additional information in Schaverien “Organometallic Chemistry of the Lanthanides,” Advances in Organometallic Chemistry, 1994, vol. 36, pp. 283-362, which is incorporated herein by reference. In addition, it is within the scope of this invention to have substituents on the R groups that provide additional stability to the erbium metal center, such as via an amino substituent. In some preferred embodiments, all three R groups are not a naphthenate having the structure C₅H₉(CH₂)ₙ—COO—, where n is an integer greater than zero. In some preferred embodiments, all three R groups are not a 2-dialkylaminobenzyl or a 2-dialkylaminomethylphenyl.

In addition to the three R groups attached to the erbium metal precursor, additional neutral groups may be attached to the erbium, designated L herein. Each L group attached to the erbium may be selected from the group consisting of carbon monoxide, isocyanide, nitrous oxide, PA₃, NA₃, OA₂, SA₂, SeA₂, and combinations thereof, wherein each A is independently selected from a group consisting of alkyl, substituted alkyl, heteroalkyl, cycloalkyl, substituted cycloalkyl, heterocycloalkyl, substituted heterocycloalkyl, aryl, substituted aryl, heteroaryl, substituted heteroaryl, and silyl. Optionally, two or more A groups may be linked to form one or more ring structures with the other atoms; thus, for example, OA₂ includes tetrahydrofuran, and bicyclic rings are included. The number of L groups is dependent on each of the groups chosen for R, but theoretically there may be up to five L groups attached to the erbium atom in the metal precursor, meaning that 0, 1, 2, 3, 4 or 5 L groups may be datively bonded to the Er atom. Additionally, two or more L groups may connected together with a linking group to form chelating neutral groups (for example, N,N,N′,N′-tetramethylethylenediamine).

In yet other embodiments, the erbium metal precursor may be an ionic complex with an appropriate counter balancing charge from one or more counterions. Thus, ErR₄⁻ is within the scope of this invention with an appropriate counter balancing cation, such as Li(OA₂)ₙ⁺ (with the previous definition of n), giving for example, Er(tert-butyl)₄⁻ Li(O(C₂H₅)₂)₄⁺or Er(CH₃)₆³⁻ (Li(N,N,N′,N′-tetramethylethylenediamine)⁺)₃

Although a general erbium metal precursor definition was just provided, the erbium may be provided to the catalytic composition as a metal atom, ion, compound or other metal precursor compound. In many applications, the compositions of this invention will be combined and the product of such combination is not determined, if a product indeed forms. For example, the components of the composition may or may not be added to a reaction vessel at the same time as the reactants, i.e., monomers or other polymerization reaction components (e.g., such as scavengers, solvents, etc.).

### Polymerization Activators/Additives

The erbium metal precursors are active catalysts in combination with a suitable activator or activating technique, and optionally one or more ligands. Broadly, the activator may comprise alumoxanes, Lewis acids, Bronsted acids, compatible non-interfering activators and combinations of the foregoing. The foregoing activators have been taught for use with different compositions or metal complexes in the following references, which are hereby incorporated by reference in their entirety: U.S. Pat. Nos. 5,599,761, 5,616,664, 5,453,410, 5,153,157, 5,064,802, and EP-A-277,004. In particular, ionic or ion forming activators are preferred.

Suitable ion forming compounds useful as an activator in one embodiment of the present invention comprise a cation which is a Bronsted acid capable of donating a proton, and an inert, compatible, non-interfering, anion, A⁻. Preferred anions are those containing a single coordination complex comprising a charge-bearing metal or metalloid core. Mechanistically, said anion should be sufficiently labile to be displaced by olefinic, diolefinic and acetylenically unsaturated compounds or other neutral Lewis bases such as ethers or nitrites. Suitable metals include, but are not limited to, aluminum, gold and platinum. Suitable metalloids include, but are not limited to, boron, phosphorus, and silicon. Compounds containing anions that comprise coordination complexes containing a single metal or metalloid atom are, of course, well known and many, particularly such compounds containing a single boron atom in the anion portion, are available commercially.

Preferably such activators may be represented by the following general formula:

(L*—H)_{d}⁺(A^{d-})

wherein, L* is a neutral Lewis base; (L*−H)⁺ is a Bronsted acid; A^{d-} is a non-interfering, compatible anion having a charge of d−, and d is an integer from 1 to 3. More preferably A^{d-} corresponds to the formula: [M′³⁺ Qₕ]^{d-} wherein h is an integer from 4 to 6; h−3=d; M′ is an element selected from Group 13 of the Periodic Table of the Elements; and Q is independently selected from the group consisting of hydride, dialkylamido, halide, alkoxide, aryloxide, hydrocarbyl, and substituted-hydrocarbyl radicals (including halosubstituted hydrocarbyl, such as perhalogenated hydrocarbyl radicals), said Q having up to 20 carbons. In a more preferred embodiment, d is one, i.e., the counter ion has a single negative charge and corresponds to the formula A⁻.

Activators comprising boron or aluminum which are particularly useful in the preparation of catalysts of this invention may be represented by the following general formula:

[L*—H]⁺[JQ₄]⁻

wherein: L* is as previously defined; J is boron or aluminum; and Q is a fluorinated C₁₋₂₀ hydrocarbyl group. Most preferably, Q is independently selected from the group selected from the group consisting of fluorinated aryl group, especially, a pentafluorophenyl group (i.e., a C₆F₅ group) or a 3,5-bis(CF₃)₂C₆H₃ group. Illustrative, but not limiting, examples of boron compounds which may be used as an activating cocatalyst in the preparation of the improved catalysts of this invention are tri-substituted ammonium salts such as: trimethylammonium tetraphenylborate, triethylammonium tetraphenylborate, tripropylammonium tetraphenylborate, tri(n-butyl)ammonium tetraphenylborate, tri(t-butyl)ammonium tetraphenylborate, N,N-dimethylanilinium tetraphenylborate, N,N-diethylanilinium tetraphenylborate, N,N-dimethylanilinium tetra-(3,5-bis(trifluoromethyl)phenyl)borate, N,N-dimethyl-(2,4,6-trimethylanilinium) tetraphenylborate, trimethylammonium tetrakis(pentafluorophenyl) borate, triethylammonium tetrakis(pentafluorophenyl) borate, tripropylammonium tetrakis(pentafluorophenyl) borate, tri(n-butyl)ammonium tetrakis(pentafluorophenyl) borate, tri(secbutyl)ammonium tetrakis(pentafluorophenyl) borate, N,N-dimethylanilinium tetrakis(pentafluorophenyl) borate, N,N-diethylanilinium tetrakis(pentafluorophenyl) borate, N,N-dimethyl-(2,4,6-trimethylanilinium) tetrakis(pentafluorophenyl) borate, trimethylammonium tetrakis-(2,3,4,6-tetrafluorophenylborate and N,N-dimethylanilinium tetrakis-(2,3,4,6-tetrafluorophenyl) borate; dialkyl ammonium salts such as: di-(i-propyl)ammonium tetrakis(pentafluorophenyl) borate, and dicyclohexylammonium tetrakis(pentafluorophenyl) borate; and tri-substituted phosphonium salts such as: triphenylphospnonium tetrakis(pentafluorophenyl) borate, tri(o-tolyl)phosphonium tetrakis(pentafluorophenyl) borate, and tri(2,6-dimethylphenyl)phosphonium tetrakis(pentafluorophenyl) borate; and N,N-dimethylanilinium tetrakis(3,5-bis(trifluoromethyl)phenyl)borate. Preferred [L*—H]⁺ cations are N,N-dimethylanilinium and tributylammonium. Preferred anions are tetrakis(3,5-bis(trifluoromethyl)phenyl)borate and tetrakis(pentafluorophenyl)borate. In some embodiments, the most preferred activator is PhNMe₂H⁺B(C₆F₅)₄⁻.

Other suitable ion forming activators comprise a salt of a cationic oxidizing agent and a non-interfering, compatible anion represented by the formula:

(OX^{e+})_{d}(A^{d-})ₑ

wherein: Ox^{e+} is a cationic oxidizing agent having a charge of e+; e is an integer from 1 to 3; and A^{d-}, and d are as previously defined. Examples of cationic oxidizing agents include: ferrocenium, hydrocarbyl-substituted ferrocenium, Ag⁺, or Pb⁺². Preferred embodiments of A^{d-} are those anions previously defined with respect to the Bronsted acid containing activating cocatalysts, especially tetrakis(pentafluorophenyl)borate.

Another suitable ion forming, activating cocatalyst comprises a compound which is a salt of a carbenium ion or silyl cation and a non-interfering, compatible anion represented by the formula:

©⁺A⁻

wherein: ©⁺ is a C₁₋₁₀₀ carbenium ion or silyl cation; and A⁻ is as previously defined. A preferred carbenium ion is the trityl cation, i.e. triphenylcarbenium. The silyl cation may be characterized by the formula Z¹Z²Z³Si⁺ cation, where each of Z¹, Z², and Z³ is independently selected from the group consisting of alkyl, substituted alkyl, cycloalkyl, heterocycloalkyl, heterocyclic, aryl, substituted aryl, heteroaryl, substituted heteroaryl and combinations thereof. In some embodiments, a most preferred activator is Ph₃C⁺B(C₆F₅)₄⁻.

In addition, suitable activators include Lewis acids, such as those selected from the group consisting of tris(aryl)boranes, tris(substituted aryl)boranes, tris(aryl)alanes, tris(substituted aryl)alanes, including activators such as tris(pentafluorophenyl)borane. Other useful ion forming Lewis acids include those having two or more Lewis acidic sites, such as those described in WO 99/06413 or Piers, et al. “New Bifunctional Perfluoroaryl Boranes: Synthesis and Reactivity of the ortho-Phenylene-Bridged Diboranes 1,2-[B(C₆F₅)₂]₂C₆X₄ (X—H, F)”, J. Am. Chem. Soc., 1999, 121, 3244-3245, both of which are incorporated herein by reference. Other useful Lewis acids will be evident to those of skill in the art. In general, the group of Lewis acid activators are within the group of ion forming activators (although exceptions to this general rule can be found) and the group tends to exclude the group 13 reagents listed below. Combinations of ion forming activators may be used.

Other general activators or compounds useful in a polymerization reaction may be used. These compounds may be activators in some contexts, but may also serve other functions in the polymerization system, such as alkylating an erbium metal center or scavenging impurities. These compounds are within the general definition of “activator,” but are not considered herein to be ion forming activators. These compounds include a group 13 reagent that may be characterized by the formula G¹³R′₃₋ₚDₚ where G¹³ is selected from the group consisting of Al, B, Ga, In and combinations thereof, p is 0, 1 or 2, each R′ is independently selected from the group consisting of alkyl, substituted alkyl, cycloalkyl, heterocycloalkyl, heterocyclic and combinations thereof, and each D is independently selected from the group consisting of halide, hydride, alkoxy, aryloxy, amino, thio, phosphino and combinations thereof. In other embodiments, the group 13 activator is an oligomeric or polymeric alumoxane compound, such as methylalumoxane and the known modifications thereof. In other embodiments, a divalent metal reagent may be used that is defined by the general formula M′R′₂₋ₚ,Dₚ, and p′ is 0 or 1 in this embodiment and R′ and D are as defined above. M′ is the metal and is selected from the group consisting of Mg, Ca, Sr, Ba, Zn, Cd and combinations thereof. In still other embodiments, an alkali metal reagent may be used that is defined by the general formula M″R′ and in this embodiment R′ is as defined above. M″ is the alkali metal and is selected from the group consisting of Li, Na, K, Rb, Cs and combinations thereof. Additionally, hydrogen and/or silanes may be used in the catalytic composition or added to the polymerization system. Silanes may be characterized by the formula SiR′_{4-q}D_{q} where R′ is defined as above, q is 1, 2, 3 or 4 and D is as defined above, with the proviso that there is at least one D that is a hydride.

The molar ratio of erbium metal precursor:activator employed preferably ranges from 1:10,000 to 100:1, more preferably from 1:5000 to 10:1, most preferably from 1:10 to 1:1. In a preferred embodiment of the invention mixtures of the above compounds are used, particularly a combination of a group 13 reagent and an ionic activator (i.e., those with a positive and negative charge). The molar ratio of group 13 reagent to ionic activator is preferably from 1:10,000 to 1000:1, more preferably from 1:5000 to 100:1, most preferably from 1:100 to 100:1. In a preferred embodiment, the ion forming activators are combined with a tri-alkyl aluminum, specifically trimethylaluminum, triethylaluminum, or triisobutylaluminum or with a di-alkyl aluminum hydride such as di-isobutyl aluminum hydride.

### Ligands

One or more ligands are an optional addition to the catalyst composition of the erbium metal precursor and at least one activator or activating technique. The ligands useful in this invention broadly are those ligands that bind metal ions (e.g., via covalent bonds, dative bonds or combinations thereof). Ligand characteristics that can be varied include, but are not limited to, the number of coordination sites on the metal which the ligand can occupy, the charge and electronic influence of the ligand, the geometry imposed on the metal by the ligand, the geometry imposed on the ligand by the metal, etc. A plethora of metal-binding ligands are known in the art. See, for example, Collman, J. P., et al. PRINCIPLES AND APPLICATIONS OF ORGANOTRANSITION METAL CHEMISTRY, University Science Books, California, 1987, and references therein which are herein incorporated by reference. The metal-ligand compounds or complexes may have more than one geometry.

Generally, the coordination sites of the ligand are 1, 2, 3 or 4, and the charge on the ligands are 0, −1, −2, or −3. By “charge on the ligand,” in one embodiment, it is intended that this number refer to the number of non-dative covalent bonds that could be formed with the erbium metal center. In another embodiment, “charge on the ligand” refers to the charge that one skilled in the art would assign to the ligand to balance the overall charge of the metal-ligand complex when the metal center is considered to be an ion with a positive charge that is equivalent to the oxidation state of the metal, and may be represented by M^{m+} with M being the metal and m being the oxidation state (which, e.g., for erbium is M−Er and m is typically 3). Other ligands include those wherein the charge is greater than the number of sites it occupies. Due to the nature of their structure, certain ligands will have more than one possible coordination number and/or more than one possible charge. Also, a ligand may be deprotonated prior to use with the erbium metal precursor or may be deprotonated upon reaction with the erbium metal precursor, for example upon reaction with ErR₃ to eliminate RH in the process of forming the metal-ligand complex or compound.

Examples of ligands that can be used in the present invention include, but are not limited to, the following:

One-site, monoanionic ligands such as those that might form a complex like Cp*ErR⁺A⁻ (wherein R is as defined above and A⁻=anion as defined above), and other mono-Cp systems or such as aryloxy that might form a complex like (aryloxy)ErR⁺A⁻;

Two-site, dianionic ligands, which include, for example, mono-Cp systems where a heteroatom based ancillary ligand occupies the second site (referred to in U.S. Pat. No. 5,064,802, the teachings of which are incorporated herein by reference); non-Cp amide systems (referred to in U.S. Pat. Nos. 5,318,935, 5,495,036 and J. Am. Chem. Soc. 1996, 118:10008-10009, the teachings of which are incorporated herein by reference);

Two site, monoanionic ligands including, for example, those that might form a complex like (CpL)ErR⁺A⁻ (where the L is as defined above, but is covalently linked to the cyclopentadienyl group, which may also include other substituents) and related systems (referred to in WO 96/13529, the teachings of which are incorporated herein by reference) or mono-Cp systems where a heteroatom based occupies the second site (such as European Patent Application 0 805 142 A1, WO 97/42232 and WO 97/42239, each of which are incorporated herein by reference).

Two site, neutral ligands;

Three site, neutral ligands;

Three site, monoanionic ligands;

Three site, dianionic ligands (an example of which is referred to in Organometallics 1995, 14:3154-3156, which is incorporated herein by reference);

Four site, neutral, monoanionic and dianionic ligands; and

Ligands where the charge is greater than the number of sites it occupies (see, for example, U.S. Pat. No. 5,504,049, the teachings of which are incorporated herein by reference).

More examples of the types of ligands described above may be found by those of skill in the art in Gibson, et al., Angew. Chem. Int. Ed., 1999, vol. 38, pp. 428-447, which is incorporated herein by reference.

In preferred embodiments, the coordination numbers (CN) of the ligand are independently 1, 2, 3 or 4, and the charge on the ligands are independently 0, −1 or −2. Preferred coordination numbers and charges are: (i) CN=2, charge=−2; (ii) CN=2, charge=−1; (iii) CN=1, charge=−1; (iv) CN=2, charge=0; (v) CN=3, charge=−1; (vi) CN=3, charge=−2; (vii) CN=3, charge=0; (viii) CN=4, charge=0; (ix) CN=4, charge=−1; (x) CN 4, charge=−2 and (xi) CN=1, charge=0. In other embodiments, the ligand has a charge, which is greater than the number of coordination sites it occupies on a metal ion, such as a CN=1 and charge=−2 ligand, for example imido ligands that are referred to in Gibson et al., Id. Thus, the format used to describe the classes of ligands herein is where the first number refers to the coordination number and the second number refers to the ligand charge, which appears as (coordination number, charge). Therefore, a (2, −2) ligand is a CN=2 and charge=−2 ligand.

Using the (coordination number, charge) notation, the ligands useful in this invention may be characterized by the formula:

{(a,0)ᵢ(b,c)ⱼ}

where a is the coordination number and is an integer from 1-4, b is the coordination number and is an integer from 1-4, c is the ligand charge and is −1 or −2, i is an integer from 0-5 and j is 0, 1 or 2, provided that the sum of i+j is greater than or equal to 1. Also, when c is −1, j is 1 or 2 and when c is −2, j is 1. The first part of this formula (a,0) is directed toward neutral ligands (charge=0) and may be provided by an atom with a lone pair of electrons (such as O, N, P, S or C with appropriate other substituents (e.g., carbenes when the atom is C)) or by a bond (such as an in an agostic interaction or a pi (π) bond). The second part of this formula (b,c) is directed toward charged ligands and may be provided by one or more atoms (such as C, S, O, N, P, B, Si, Se, As, Te, with appropriate other substituents) or by a bond (such a pi (π) bond).

Selected examples of ligands that may be used in this invention, and showing the appropriate notation (coordination number, charge) are shown below. These ligands are shown in their protonated form, but may be de-protonated as described above.

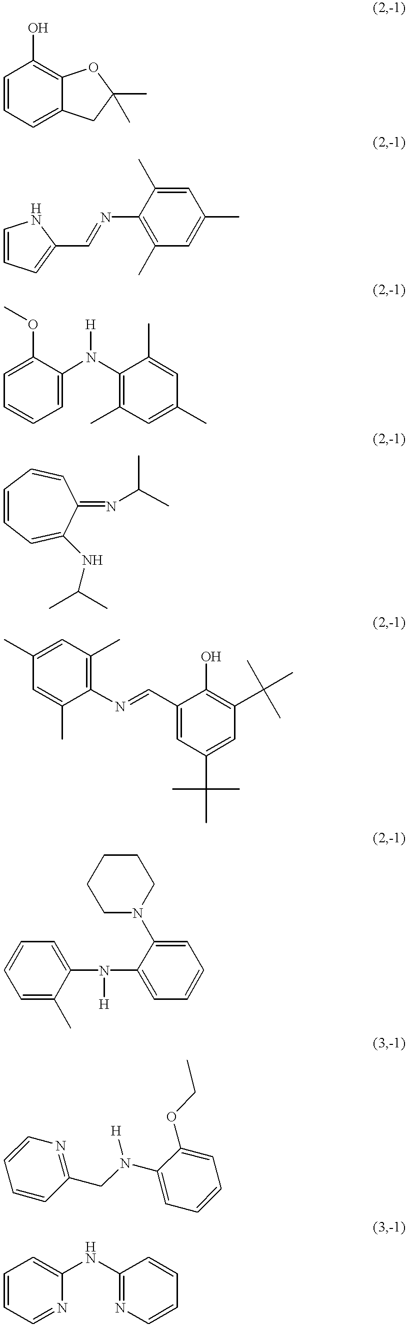

In other applications, the ligand will be mixed with a suitable metal precursor compound prior to or simultaneous with allowing the mixture to be contacted to the reactants. When the ligand is mixed with the metal precursor compound, a metal-ligand complex may be formed, which may be a catalyst. In connection with the metal complex and depending on the ligand or ligands chosen, the erbium metal complex may take the form of dimers, trimers or higher orders thereof or there may be two or more erbium atoms that are bridged by one or more ligands. Furthermore, two or more ligands may coordinate with a single erbium atom. The exact nature of the metal complex(es) or compound(s) formed depends on the exact chemistry of the ligand and the method of combining the erbium metal precursor and ligand, such that a distribution of erbium metal complexes may form with the number of ligands bound to the metal being greater or less than the number of equivalents of ligands added relative to an equivalent of erbium metal precursor.

The ligands may be supported, with or without the erbium metal coordinated, on an organic or inorganic support. Suitable supports include silicas, aluminas, clays, zeolites, magnesium chloride, polyethyleneglycols, polystyrenes, polyesters, polyamides, peptides and the like. Polymeric supports may be cross-linked or not. Similarly, the metal may be supported with or without the ligand, on similar supports known to those of skill in the art.

### Metal Complexes

As discussed above, the erbium metal precursor may be combined with one or more ligands, and thus, an erbium metal complex or compound may be formed. Such complexes or compounds may be characterized by the formula:

{(a,0)ᵢ(b,c)ⱼ}ErR_{3+(jc)}

where a, b, c, i, j, and R each have the above definitions and jc is the product of j multiplied by c. The coordination of the ligand or ligands to the erbium atom will be governed by those chemical principles known to those of skill in the art, including principles such as steric interactions as well as electronic configurations. If the above complex bears a charge of w, then the formula would be [{(a,0)ᵢ (b,c)ⱼ}ErR_{3+(jc)-w}]^{w} where w is a integer that is −3, −2, −1, 1, or 2.

When activated with an ion forming activator (which are discussed above), the erbium metal complexes may be characterized by the formula:

[{(a,0)ᵢ(b,c)ⱼ}ErR_{2+(jc)}]⁺[A]⁻

where each of the variables in the above formula has the above definitions. Thus, for example, A may be B(C₆F₅)₄ as discussed above. Moreover, since some embodiments of this invention utilize one or more additional reagents (as described above), the erbium metal complexes useful in this invention may form bridged species with the group 13 or divalent or alkali metal reagents. Optionally, this complex may be charged and may be associated with a suitable counterion.

### Monomers/Polymers

The compositions and catalysts herein may be used to polymerize olefinically or acetylenically unsaturated monomers having from 2 to 20 carbon atoms either alone or in combination. The compounds and catalysts of this invention may also usefully polymerize functionalized monomers. Monomers include olefins, diolefins and acetylenically unsaturated monomers including ethylene and C₃ to C₂₀ α-olefins such as propylene, 1-butene, 1-hexene, 1-octene, 4-methyl-1-pentene, 1-norbornene, styrene and mixtures thereof; additionally, 1,1-disubstituted olefins, such as isobutylene, either alone or with other monomers such as ethylene or C₃ to C₂₀ α-olefins and/or diolefins. These definitions are intended to include cyclic olefins. Diolefins generally comprise 1,3-dienes such as (butadiene), substituted 1,3-dienes (such as isoprene) and other substituted 1,3-dienes, with the term substituted referring to the same types of substituents referred to above in the definition section. Diolefins also comprises 1,5-dienes and other non-conjugated dienes. The styrene monomers may be unsubstituted or substituted at one or more positions on the aryl ring. The use of diolefins in this invention is typically in conjunction with another monomer that is not a diolefin.

More specifically, it has been found that the erbium based catalysts of the present invention are particularly active for certain monomers, particularly α-olefins that have a chain length of C₄ or higher. Thus, the catalysts of the present invention may provide higher comonomer incorporation for copolymers of ethylene and co-monomers having four or more carbon atoms. In addition, the erbium based catalysts of the present invention may polymerize vinyl chloride alone (e.g., in a homopolymerization) or with other monomers (such as ethylene or C₃ to C₂₀ α-olefins). Furthermore, vinyl monomers with functional groups may also be polymerized alone (e.g., in a homopolymerization) or with other monomers (such as ethylene or C₃ to C₂₀ α-olefins). Such functional group containing vinyl monomers can be characterized by the general formula H₂C═CH—FG, where FG is the functional group that contains at least one heteroatom (using the previous definition) or halogen (e.g., Cl, F, Br, etc.). Functional monomers include C₁-C₂₀ acrylates, C₁-C₂₀ methacrylates, acrylic acid, methacrylic acid, maleic anhydride, vinyl acetate, vinyl ethers, acrylonitrile, acrylamide, vinyl chloride and mixtures thereof.

In some embodiments of the invention, certain types of polymerizations are excluded, including specific homopolymerizations and copolymerizations of specific monomers or monomer combinations.

Novel polymers, copolymers or interpolymers may be formed having unique physical and/or melt flow properties. Such novel polymers can be employed alone or with other polymers in a blend to form products that may be molded, cast, extruded or spun. End uses for the polymers made with the catalysts of this invention include films for packaging, trash bags, bottles, containers, foams, coatings, insulating devices and household items. Also, such functionalized polymers are useful as solid supports for organometallic or chemical synthesis processes.

### Polymerization Systems

Polymerization can be carried out in the Ziegler-Natta or Kaminsky-Sinn methodology, including temperatures of from −100° C. to 300° C. and pressures from atmospheric to 3000 atmospheres. Suspension, solution, slurry, gas phase or high-pressure polymerization processes may be employed with the catalysts and compounds of this invention. Such processes can be run in a batch, semi-batch or continuous mode. Examples of such processes are well known in the art. A support for the catalyst may be employed, which may be inorganic (such as alumina, magnesium chloride or silica) or organic (such as a polymer or cross-linked polymer). Methods for the preparation of supported catalysts are known in the art. Slurry, suspension, solution and high-pressure processes as known to those skilled in the art may also be used.

Suitable solvents for polymerization are noncoordinating, inert liquids. Examples include straight and branched-chain hydrocarbons such as isobutane, butane, pentane, hexane, heptane, octane, and mixtures thereof; cyclic and alicyclic hydrocarbons such as cyclohexane, cycloheptane, methylcyclohexane, methylcycloheptane, and mixtures thereof; perfluorinated hydrocarbons such as perfluorinated C₄₋₁₀ alkanes, and aromatic and alkylsubstituted aromatic compounds such as benzene, toluene, and xylene. Suitable solvents also include liquid olefins which may act as monomers or comonomers including ethylene, propylene, 1-butene, butadiene, cyclopentene, 1-hexene, 1-pentene, 3-methyl-l-pentene, 4-methyl-1-pentene, 1,4-hexadiene, 1-octene, 1-decene, isobutylene, styrene, divinylbenzene, allylbenzene, vinyltoluene (including all isomers alone or in admixture), vinyl chloride, acrylonitrile, acrylates, vinyl acetate, methacrylates, 4-vinylcyclohexene, and vinylcyclohexane. Mixtures of the foregoing are also suitable.

Other additives that are useful in a polymerization reaction may be employed, such as scavengers, promoters, etc.

### Combinatorial Methodology

The metal complexes and compositions of this invention can be prepared and tested for catalytic activity in one or more of the above reactions in a combinatorial fashion. Combinatorial chemistry generally involves the parallel or rapid serial synthesis and/or screening or characterization of compounds and compositions of matter. U.S. Pat. No. 5,985,356 and WO 98/03521, both of which are incorporated herein by reference, generally disclose combinatorial methods. In this regard, the metal precursors, ligands, complexes or compositions may be prepared and/or tested in rapid serial and/or parallel fashion, e.g., in an array format. When prepared in an array format, for example, the metal precursors, activators and/or ligands may be take the form of an array comprising a plurality of compounds wherein each compound can be characterized by the general formulas described above. Typically, each member of the array will have differences so that, for example, a ligand or activator or R group in a first region of the array may be different than the ligand or activator or R group in a second region of the array. Other variables may also differ from region to region in the array.

In such a combinatorial array, typically each of the plurality of compositions or complexes has a different composition or stoichiometry, and typically each composition or complex is at a selected region on a substrate such that each compound is isolated from the other compositions or complexes. This isolation can take many forms, typically depending on the substrate used. If a flat substrate is used, there may simply be sufficient space between regions so that there cannot be interdiffusion between compositions or complexes. As another example, the substrate can be a microtiter or similar plate having wells so that each composition or complex is in a region separated from other compounds in other regions by a physical barrier. The array may also comprise a parallel reactor or testing chamber.

The array typically comprises at least 8 compounds, complexes or compositions each having a different chemical formula, meaning that there must be at least one different atom or bond differentiating the members in the array or different ratios of the components referred to herein (with components referring to erbium metal precursors, activators, group 13 reagents, solvents, monomers, supports, etc.). In other embodiments, there are at least 20 compounds, complexes or compositions on or in the substrate each having a different chemical formula. In still other embodiments, there are at least 40 or 90 or 124 compounds, complexes or compositions on or in the substrate each having a different chemical formula. Because of the manner of forming combinatorial arrays, it may be that each compound, complex or composition may not be worked-up, purified or isolated, and for example, may contain reaction by-products or impurities or unreacted starting materials.

The catalytic performance of the compounds, complexes or compositions of this invention can be tested in a combinatorial or high throughput fashion. Polymerizations can also be performed in a combinatorial fashion, see, e.g., provisional U.S. patent application Ser. Nos. 09/211,982, filed Dec. 14, 1998 and 09/239,223, filed Jan. 29, 1999, each of which is herein incorporated by reference.

### EXAMPLES

General: All reactions were performed under a purified argon or nitrogen atmosphere in a Vacuum Atmospheres glove box. All solvents used were of the anhydrous, de-oxygenated and purified according to known techniques. Polymerizations were carried out in a parallel pressure reactor, which is fully described in pending U.S. patent applications Ser. Nos. 09/177,170, filed Oct. 22, 1998, 09/211,982, filed Dec. 14, 1998 and 09/239,223, filed Jan. 29, 1999, and WO 00/09255, each of which is incorporated herein by reference.

High temperature Size Exclusion Chromatography was performed using an automated “Rapid GPC” system as described in U.S. Pat. No. 6,175,409, incorporated herein by reference and U.S. patent application Ser. Nos. 09/285,363; 09/285,333; 09/285,335; or 09/285,392; each of which was filed on Apr. 2, 1999 and each of which is incorporated herein by reference. In the current apparatus, a series of two 30 cm×7.5 mm linear columns, with one column containing PLgel 10 um, MixB and the other column containing PLgel 5 um, MixC. The columns were calibrated using narrow polystyrene standards. A flow rate of 1.5 mL/min. was used, with an injection volume of 40 μL of a polymer solution with a concentration of about 1 mg/mL, an oven temperature of 160° C., and the polymer samples dissolved in o-dichlorobenzene. The concentration of the polymer in the eluent was monitored using an evaporative light scattering detector. All of the molecular weight results obtained are relative to linear polystyrene standards.

FTIR was performed on a Bruker Equinox 55+IR Scope II in reflection mode with 16 scans, to determine the ratio of octene to ethylene incorporated in the polymer product, represented as the weight % (wt. %) of octene incorporated in the polymer (wt. % octene). Wt. % octene was obtained from ratio of peak heights at 1378 cm⁻¹ and 4335 cm⁻¹. This method was calibrated using a set of ethylene/1-octene copolymers with a range of known wt. % octene content.

Er(OC₆H₃-2,6-t-Bu₂)₃ was prepared from the reaction of ErCl₃ (purchased from Alfa Aesar, ultradry anhydrous, 99.9%,) with 3 equivalents of LiOC₆H₃-2,6-t-Bu₂ in THF following the procedure employed by Lappert for the synthesis of Sm(OC₆H₃-2,6-t-Bu₂)₃ and other Ln(OAr)₃ complexes (Lappert et al., Inorganic Syntheses, vol. 27 (1990), pp. 164-168, and Lappert et al., J Chem. Soc. Chem. Commun., 1983, pp. 1499-1501, each of which is incorporated herein by reference). Er(CH(SiMe₃)₂)₃ was prepared via the reaction of Er(OC₆H₃-2,6-t-Bu₂)₃ with 3 equivalents of LiCH(SiMe₃)₂ in hexane, using the procedure described by Lappert for the synthesis of La(CH(SiMe₃)₂)₃ and Sm(CH(SiMe₃)₂)₃ (Lappert et al., J. Chem. Soc. Chem. Commun., 1988, pp. 1007-1009, incorporated herein by reference) and by Schaverien for the synthesis of Lu(CH(SiMe₃)₂)₃ and Y(CH(SiMe₃)₂) (Schaverien et al., Inorg. Chem., 1991, 30, pp. 4968-4978, incorporated herein by reference).

### Examples 1 and 2: Ethylene-1-Octene Copolymerizations

Stock solutions: Four stock solutions were prepared as follows: The “metal precursor solution” is a 30 mM solution of Er(CH(SiMe₃)₂)₃ in toluene (82 mg in 4 mL). The “ligand solution” is a 30 mM solution of 2,3-dihydrido-2,2-dimethyl-7-benzofuranol in toluene (200 mg in 40 mL toluene). The “group 13 reagent solution” is a 0.15 M solution of TEAL (triethylaluminum, AlEt₃) in toluene (0.41 mL of neat AlEt₃ plus 19.6 mL toluene). The “activator solution” is a 10 mM solution of triphenylcarbenium tetrakis(pentafluorophenyl)borate in toluene (74 mg in 8 mL toluene).

Preparation of the polymerization reactor prior to injection of catalyst composition: A pre-weighed glass vial insert (the reactor vessel) and disposable stirring paddle were fitted to each reaction chamber of the parallel reactor. The reactor was then closed, and 4.85 mL of toluene followed by 0.15 mL of 1-octene was injected into each reaction vessel through a valve. The temperature was then set to 35° C., and the stirring speed was set to 200 rpm, and the toluene/1-octene mixture was exposed to ethylene gas at 100 psi pressure. An ethylene pressure of 100 psi and a temperature of 35° C. were maintained, using computer control, until the end of the polymerization experiment.

Premix of metal precursor solution and ligand solution in 1 mL glass vial: 0.10 mL of the ligand solution was added to a 1 mL glass vial at room temperature. To this same vial was added, with mixing, 0.10 mL of the metal precursor solution, to form the metal-ligand combination solution.

Injection of solutions into the reactor vessel: After the toluene/1-octene mixture was saturated with ethylene at 100 psi pressure in the reaction vessel, and approximately 30 minutes after combining the metal precursor and ligand solutions in the 1 mL glass vial, 0.033 mL of the group 13 reagent solution followed immediately by 0.467 mL of toluene, were injected into the reaction vessel. About 30 seconds later, 0.067 mL of the metal-ligand combination solution followed immediately by 0.633 mL of toluene, were injected into the reaction vessel. About another 30 seconds later, an additional 0.100 mL of the “activator solution” followed immediately by 0.600 mL of toluene, were injected into the reaction vessel.

Polymerization: The polymerization reaction was allowed to continue for 1 hour, during which time the temperature and pressure were maintained at their pre-set levels by computer control. After 1 hour, the ethylene flow to the reactor vessel was stopped, and the ethylene pressure in the reactor vessel was vented.

Product work up: The glass vial insert, containing the polymer product and solvent, was then removed from the reactor and removed from the inert atmosphere dry box, and the volatile components were allowed to evaporate at room temperature in the air. After most of the volatile components had evaporated, the vial contents were dried thoroughly by evaporation at elevated temperature under reduced pressure. The vial was then weighed to determine the yield of polymer product. The polymer product was analyzed by rapid GPC, as described above, to determine the molecular weight of the polymer produced, and by FTIR spectroscopy to determine the ratio of octene to ethylene incorporated in the polymer product, represented as the weight % of octene incorporated in the polymer. Results are presented in the Table 1:

TABLE 1
Use of Erbium compounds as catalysts for ethylene/1-octene
copolymerization:

| | | | Copolymer | | wt. % |
|---|---|---|---|---|---|
| Example # | μmol Er | Temp. (° C.) | yield (g) | Mw | 1-octene |
| 1 | 1.0 | 35 | 0.312 | 2.2 × 10⁵ | 9 |
| 2 | 1.0 | 35 | 0.466 | 2.3 × 10⁵ | 8 |

### Examples 3-7: Ethylene-1-Octene Copolymerizations

In these examples a different protocol was followed as compared to Examples 1 and 2.

Ligands: The ligands chosen for these examples are as follows (see Table 2, below, showing which ligands are for which examples):

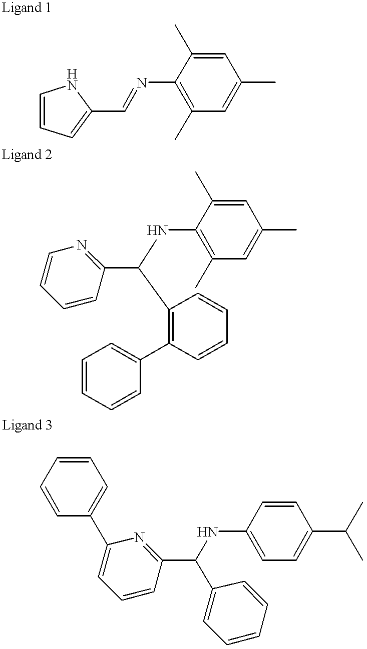

Stock solutions: The “group 13 reagent solution” is a 0.20 M solution of di-isobutylaluminum hydride (DIBAL-H). The “activator solution” is a 5 mM solution of N,N′-dimethylanilinium tetrakis(pentafluorophenyl)borate in toluene, heated to approximately 85° C. to fully dissolve the N,N′-dimethylanilinium tetrakis(pentafluorophenyl)borate.

In situ preparation of erbium-ligand compositions: Stock solutions were prepared as follows: The “metal precursor solution” is a 10 mM solution of Er(CH(SiMe₃)₂)₃ in toluene. The “ligand solutions” are 25 mM solutions of the ligands in toluene, prepared in an array of 1 mL glass vials by adding 0.040 mL of toluene to 1.0 μmol of the ligand in a 1 mL glass vial. To each 1 mL glass vial containing ligand/toluene solution was added 0.10 mL of the metal precursor solution (1.0 μmol), to form the metal-ligand combination solution. The resultant solutions are allowed to sit at room temperature for 1 hour prior to addition of the 1-octene, DIBAL-H, and N,N′-dimethylanilinium tetrakis(pentafluorophenyl)borate solutions, and injection into the reactor, as described below.

Preparation of the polymerization reactor prior to injection of catalyst composition; A pre-weighed glass vial insert (the reactor vessel) and a disposable stirring paddle were fitted to each reaction chamber of the parallel reactor. The reactor was then closed, 0.10 mL of a 0.02 M solution of DIBAL-H in toluene, then 3.8 mL of toluene, were injected into each pressure reaction vessel through a valve. The temperature was then set to the appropriate setting, and the stirring speed was set to 800 rpm, and the toluene/DIBAL-H mixture was exposed to ethylene gas at 100 psi pressure. An ethylene pressure of 100 psi and the temperature setting were maintained, using computer control, until the end of the polymerization experiment.

Injection of solutions into the pressure reactor vessel: After metal-ligand combination in the 1 mL vial had been allowed to sit at room temperature for 1 hour, 0.030 mL of a 1.0 M 1-octene solution in toluene (30 μmol of 1-octene) was added to the 1 mL vial. Next, 0.42 mL of 1-octene followed immediately by 0.38 mL of toluene, were injected into the pressurized, stirred, and heated, reaction vessel containing the toluene/DIBAL-H mixture saturated with ethylene at 100 psi pressure. Next, 0.030 mL (6 μmol ) of the group 13 reagent (DIBAL-H) solution was added to the 1 mL vial. About 90 seconds later, 0.240 mL (1.2 μmol) of the “activator solution” was added to the 1 mL vial. About another 30 seconds later, 0.220 mL of the 1 mL vial contents, followed immediately by 0.180 mL of toluene, were injected into the reaction vessel, followed immediately by a further 0.400 mL of toluene.

Polymerization: The polymerization reaction was allowed to continue for 15 minutes, during which time the temperature and pressure were maintained at their pre-set levels by computer control. After 15 minutes, the reaction was quenched by addition of an overpressure of carbon dioxide.

Product work up: The glass vial insert, containing the polymer product and solvent, was then removed from the reactor and removed from the inert atmosphere dry box, and the volatile components were removed in a centrifuge evaporator under reduced pressure. The vial contents were then dried thoroughly by evaporation at elevated temperature under reduced pressure. The vial was then weighed to determine the yield of polymer product. The polymer product was then analyzed by rapid GPC, as described above, to determine the molecular weight of the polymer produced, and by FTIR spectroscopy to determine the ratio of octene to ethylene incorporated in the polymer product, represented as the weight % of octene incorporated in the polymer. Results are presented in the Table 2:

TABLE 2
Use of Erbium compounds as catalysts for ethylene/1-octene
copolymerization:

| | | | Copolymer | | |
|---|---|---|---|---|---|
| Example # | | Temp. | yield | | wt. % |
| and Ligand # | μmol Er | (° C.) | (mg) | Mw | 1-octene |
| Ex. 3, L1 | 0.5 | 110 | 55 | 2.7 × 10⁵ | 5 |
| Ex. 4, L2 | 0.5 | 110 | 36 | 8.8 × 10⁴ | 4 |
| Ex. 5, L3 | 0.5 | 110 | 36 | 1.3 × 10⁵ | 5 |
| Ex. 6, No | 0.5 | 110 | 20 | 1.1 × 10⁵ | 7 |
| Ligand | | | | | |
| Ex. 7, No | 0.5 | 75 | 172 | 7.5 × 10⁴ | 4 |
| Ligand | | | | | |

It is to be understood that the above description is intended to be illustrative and not restrictive. Many embodiments will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated herein by reference for all purposes.

What is claimed is:

1. A polymerization reaction or process employing a composition comprising an erbium metal precursor and at least one activator wherein said erbium metal precursor is characterized by the formula ErR₃ where each R is independently selected from the group consisting of alkyl, substituted alkyl, aryl, substituted aryl, aryloxy, alkoxy, cycloalkyl, substituted cycloalkyl, heteraryl, substituted heteraryl, carboxylates, hydride and combinations thereof, provided that R₃ do not include the following groups bonded directly to the erbium atom: two cyclopentadienyl groups, three 2-dialkylaminobenzyl groups, three 2-dialkylaminomethylphenyl groups, three napthenate groups, an acetylide group, two or more isopropoxy groups, or three trifluoroacetate groups.

2. A polymerization reaction or process employing a composition comprising an erbium metal precursor and at least one activator wherein said erbium metal precursor is characterized by the formula ErR₃ where each R is independently selected from the group consisting of alkyl, substituted alkyl, cycloalkyl, substituted cycloalkyl, heterocycloalkyl, substituted heterocycloalkyl, cyclopentadienyl, substituted cyclopentadienyl, aryl, substituted aryl, heteroaryl, substituted heteroaryl, alkoxy, aryloxy, hydroxy, boryl, silyl, hydride, thio, seleno, phosphino, amino, carboxylates, 1,3-dionates, oxalates, carbonates, nitrates, sulfates, perchlorates and combinations thereof, wherein said reaction or process is not a homopolymerization of an alkyne monomer, copolymerization of two or more different alkyne monomers, homopolymerization of a 1,3-diene or substituted 1,3-diene monomer, copolymerization of two or more different 1,3-diene or substituted 1,3-diene monomers, copolymerization of stryene and a 1,3-diene or substituted 1,3-diene, nor homopolymerization or copolymerization of a methacylate monomer; and providing that the R groups do not include the following groups bonded directly to the erbium atom: two cyclopentadienyl groups, three 2-dialkylaminobenzyl groups, three 2-dialkylaminomethylphenyl groups or three napthenate groups.

3. A polymerization reaction or process employing a composition comprising an erbium metal precursor, an ion forming activator, and a group 13 reagent.

4. A polymerization reaction or process employing a composition comprising an erbium metal precursor, an ion forming activator, and a divalent metal reagent.

5. A polymerization reaction or process employing a composition comprising an erbium metal precursor, an ion forming activator, and an alkali metal reagent.

6. A polymerization reaction or process employing a composition comprising an erbium metal precursor, at least one activator and at least one ligand, wherein said erbium metal precursor is characterized by the formula ErR₃ where each R is independently selected from the group consisting of halide, alkyl, substituted alkyl, cycloalkyl, substituted cycloalkyl, heterocycloalkyl, substituted heterocycloalkyl, cyclopentadienyl, substituted cyclopentadienyl, aryl, substituted aryl, heteroaryl, substituted heteroaryl, alkoxy, aryloxy, hydroxy, boryl, silyl, hydride, thio, seleno, phosphino, amino, carboxylates, 1,3-dionates, oxalates, carbonates, nitrates, sulfates, perchlorates, sulfonates and combinations thereof, wherein said reaction or process is not a homopolymerization of a 1,3-diene or substituted 1,3-diene monomer, copolymerization of two or more different 1,3-diene or substituted 1,3-diene monomers or copolymerization of stryene and a 1,3-diene or substituted 1,3-diene, nor homopolymerization of a methacrylate monomer; and provided that said at least one ligand does not include 1,2-diimine ligands, bis-cyclopentadienyl ligands nor two cyclopentadienyl ligands; and providing that the R groups do not include two cyclopentadienyl groups bonded directly to the erbium atom.

7. A polymerization reaction or process employing a composition comprising an erbium metal precursor, at least one ligand, an ion forming activator and optionally a group 13 reagent, provided that said at least one ligand does not include 1,2-diimine ligands.

8. The reaction or process of either of claims 6 or 7 wherein said at least one ligand is characterized by the formula:
{(a,0)ᵢ(b,c)ⱼ}
where a is an integer from 1-4, b is an integer from 1-4, c is −1 or −2, i is an integer from 0-5 and j is 0, 1 or 2, provided that the sum of i+j is greater than or equal to 1 and provided that when c is −1, j is 1 or 2 and when c is −2, j is 1 and (a,0) represents neutral ligands that may be provided by one or more atoms with a lone pair of electrons or bonds and (b,c) represents charged ligands and may be provided by one or more atoms or bonds.

9. The reaction or process of either of claims 6 or 7 wherein said at least one ligand has a number of coordination sites selected from the group consisting of 1, 2, 3 or 4, and a charge of 0, −1 or −2.

10. A polymerization process using a catalyst composition comprising an erbium metal complex represented by the general formula:
{(a,0)ᵢ(b,c)ⱼ}ErR_{3+(jc)}
where a is an integer from 1-4; b is an integer from 1-4; c is −1 or −2; i is an integer from 0-5; j is 0, 1 or 2; and jc is the product of j times c, and provided that the sum of i+j is greater than or equal to 1 and provided that when c is −1, j is 1 or 2 and when c is −2, j is 1, (a,0) represents neutral ligands that may be provided by one or more atoms with a lone pair of electrons or bonds and (b,c) represents charged ligands and may be provided by one or more atoms or bonds; and each R group may independently be selected from the group consisting of halide, alkyl, substituted alkyl, cycloalkyl, substituted cycloalkyl, heterocycloalkyl, substituted heterocycloalkyl, cyclopentadienyl, substituted cyclopentadienyl, aryl, substituted aryl, heteroaryl, substituted heteroaryl, alkoxy, aryloxy, hydroxy, boryl, silyl, hydride, thio, seleno, phosphino, amino, carboxylates, 1,3-dionates, oxalates, carbonates, nitrates, sulfates, perchlorates, sulfonates and combinations thereof; provided that the following groups are not bonded directly to the erbium atom: two cyclopentadienyls, three 2-dialkylaminobenzyls, three 2-dialkylaminomethylphenyls, three napthenates, an acetylide, two or more isopropoxys or three trifluoroacetates; and at least one activator.

11. A polymerization process using a catalyst composition comprising an erbium metal complex represented by the general formula:
[{(a,0)ᵢ(b,c)ⱼ}ErR_{3+(jc)-w}]^{w}
where w is a integer that is −3, −2, −1, 1, or 2 and a is an integer from 1-4; b is an integer from 1-4; c is −1 or −2; i is an integer from 0-5; j is 0, 1 or 2; and jc is the product of j times c, and provided that the sum of i+j is greater than or equal to 1 and provided that when c is −1, j is 1 or 2 and when c is −2, j is 1, (a,0) represents neutral ligands that may be provided by one or more atoms with a lone pair of electrons or bonds and (b,c) represents charged ligands and may be provided by one or more atoms or bonds; and each R group may independently be selected from the group consisting of halide, alkyl, substituted alkyl, cycloalkyl, substituted cycloalkyl, heterocycloalkyl, substituted heterocycloalkyl, cyclopentadienyl, substituted cyclopentadienyl, aryl, substituted aryl, heteroaryl, substituted heteroaryl, alkoxy, aryloxy, hydroxy, boryl, silyl, hydride, thio, seleno, phosphino, amino, carboxylates, 1,3-dionates, oxalates, carbonates, nitrates, sulfates, perchlorates, sulfonates and combinations thereof; provided that the following groups are not bonded directly to the erbium atom: two cyclopentadienyls, three 2-dialkylaminobenzyls, three 2-dialkylaminomethylphenyls, three napthenates, an acetylide, two or more isopropoxys or three trifluoroacetates; and at least one activator.

12. The process or reaction of either of claims 1, 2, 3, 4, 5, 6, 7, 10 or 11, wherein said process or reaction is for polymerizing one or more monomers, comprising providing a reactor, providing said one or more monomers to said reactor, providing said composition or catalyst to said reactor, and subjecting said reactor contents to polymerization conditions.
